(19) United States
(12) Patent Application Publication
(10) Pub. No.: US 2013/0180652 A1
(43) Pub. Date: Jul. 18, 2013

(54) FLEXOGRAPHIC PRINTING PLATE PRECURSOR FOR LASER ENGRAVING AND PROCESS FOR PRODUCING SAME, LAYERED PRODUCT, AND PROCESS FOR MAKING FLEXOGRAPHIC PRINTING PLATE

(71) Applicant: FUJIFILM CORPORATION, Tokyo (JP)

(72) Inventor: Hiroyuki NAGASE, Haibara-gun (JP)

(73) Assignee: FUJIFILM CORPORATION, Tokyo (JP)

(21) Appl. No.: 13/739,767

(22) Filed: Jan. 11, 2013

(30) Foreign Application Priority Data
Jan. 13, 2012 (JP) 2012-005098

(51) Int. Cl. B32B 7/06; B41C 1/00

(52) U.S. Cl. CPC B32B 7/06; B41C 1/00
USPC 156/249; 427/385.5; 427/559; 29/426.2; 428/141; 264/400

(57) ABSTRACT

Disclosed is a flexographic printing plate precursor for laser engraving comprising: a support; a relief-forming layer provided above the support; and a foam sheet covering the relief-forming layer, the foam sheet having a surface roughness Ra of 0.02 to 1.0 mm.

### CROSS-REFERENCE TO RELATED APPLICATION

This application claims priority under 35 USC 119 from Japanese Patent Application No. 2012-005098 filed on Jan. 13, 2012, the disclosure of which is incorporated by reference herein.

### BACKGROUND OF THE INVENTION

1. Technical Field

The present invention relates to a flexographic printing plate precursor for laser engraving and a process for producing same, a layered product, and a process for making a flexographic printing plate.

2. Background Art

There have been many proposals relating to the so-called ‘direct engraving CTP method’, in which a relief-forming layer is directly engraved by means of a laser. In this method, a flexographic plate precursor is directly irradiated with a laser, and the relief-forming layer is subjected to thermal decomposition and vaporization by means of photothermal conversion, thus forming cavities. Unlike relief formation using an original image film, the direct engraving CTP method enables the relief shape to be freely controlled. Because of this, when an image such as an outline character is formed, it is possible to engrave that region more deeply than other regions, or in the case of a fine halftone dot image it is possible, taking into consideration resistance to printing pressure, to engrave while adding a shoulder, etc. As a laser used with this method, a high-output type carbon dioxide laser is generally used. In the case of a carbon dioxide laser, all organic compounds are able to absorb the irradiated energy and convert it to heat. On the other hand, inexpensive small-size semiconductor lasers have been developed, but since they employ visible and near-infrared light, it is necessary for the laser light to be absorbed and converted to heat. As an example of such a resin composition for such laser engraving, WO 2010/090345 is known.

On the other hand, a water-developable flexographic printing plate in which a slip layer is formed above a photosensitive resin layer formed above a support, a cover sheet is provided above the slip layer, and this cover sheet is a matt film having silica particles kneaded thereinto has been disclosed in JP-A-9-138499 (JP-A denotes a Japanese unexamined patent application publication).

### SUMMARY OF THE INVENTION

### Problems to be Solved by the Invention

With regard to a flexographic printing plate precursor for laser engraving, in many cases a flexible relief-forming layer is provided as a recording layer above a support; when the surface of this recording layer has tackiness, it is preferably distributed in a state in which it is covered with a cover sheet. This cover sheet preferably covers the relief-forming layer without sticking to the relief-forming layer at the time of production of the printing plate precursor. When subjecting this printing plate precursor to plate making, the cover sheet is peeled off from the recording layer before plate making. For convenience in a plate making operation, it is sometimes necessary to re-affix to a recording layer a cover sheet that has once been peeled off, but if the cover sheet is used a second time for covering, in a conventional flexographic printing plate precursor this often causes unevenness in the recording layer, and problems often occur in plate making.

An object of the present invention is to provide a flexographic printing plate precursor for laser engraving that makes it easy to cover with a cover sheet a relief-forming layer provided above a support of the flexographic printing plate precursor. It is another object of the present invention to provide a flexographic printing plate precursor for laser engraving that enables a cover sheet that has been peeled off once from a relief-forming layer to be used again for covering the relief-forming layer without causing unevenness or marks. Other objects will become apparent from the explanation below.

### Means for Solving the Problems

The objects of the present invention have been solved by means described in (1), (11), (13), and (14) below. They are described together with (2) to (10), (12), and (15) to (17), which are preferred embodiments.

(1) A flexographic printing plate precursor for laser engraving comprising a support, a relief-forming layer provided above the support, and a foam sheet covering the relief-forming layer, the foam sheet having a surface roughness Ra of 0.02 to 1.0 mm,
(2) the flexographic printing plate precursor for laser engraving according to (1), wherein the foam sheet surface area that is in contact with the relief-forming layer is smaller than that of a flat sheet,
(3) the flexographic printing plate precursor for laser engraving according to (1) or (2), wherein the surface roughness Ra is 0.03 to 0.5 mm,
(4) the flexographic printing plate precursor for laser engraving according to any one of (1) to (3), wherein the surface roughness Ra is 0.03 to 0.1 mm,
(5) the flexographic printing plate precursor for laser engraving according to any one of (1) to (4), wherein the foam sheet has a density of 10 to 80 kg/m³,
(6) the flexographic printing plate precursor for laser engraving according to any one of (1) to (5), wherein the foam sheet has a thickness of at least 0.1 mm but no greater than 5 mm,
(7) the flexographic printing plate precursor for laser engraving according to any one of (1) to (6), wherein the foam sheet is a foam sheet of polyurethane or polyethylene,
(8) the flexographic printing plate precursor for laser engraving according to any one of (1) to (7), wherein the relief-forming layer comprises a binder polymer and a photothermal conversion agent,
(9) the flexographic printing plate precursor for laser engraving according to (8), wherein it comprises carbon black as the photothermal conversion agent,
(10) the flexographic printing plate precursor for laser engraving according to any one of (1) to (9), wherein the relief-forming layer comprises a siloxane bond,
(11) a layered product in which the flexographic printing plate precursor for laser engraving according to any one of (1) to (10) is layered,
(12) the layered product according to (11), wherein 5 to 1,000 sheets of the flexographic printing plate precursor for laser engraving are layered,
(13) a process for producing the flexographic printing plate precursor for laser engraving according to any one of (1) to (10), comprising a step of forming a relief-forming layer by coating a support with a resin composition comprising a binder polymer and a photothermal conversion agent, a crosslinking step of crosslinking the relief-forming layer by means of light and/or heat to thus form a crosslinked relief-forming layer, and a step of covering the crosslinked relief-forming layer with the foam sheet,
(14) a process for making a flexographic printing plate, comprising a step of preparing the flexographic printing plate precursor for laser engraving according to any one of (1) to (10), a peeling off step of peeling off the foam sheet from the flexographic printing plate precursor for laser engraving, and an engraving step of directly laser-engraving the relief-forming layer to thus form a relief layer,
(15) the process for making a flexographic printing plate according to (14), wherein it comprises, subsequent to the peeling off step, a step of covering the relief-forming layer for a second time with a foam sheet,
(16) the process for making a flexographic printing plate according to (14) or (15), wherein in the engraving step engraving is carried out by means of a fiber-coupled semiconductor laser having a wavelength of 700 to 1,300 nm, and
(17) the process for making a flexographic printing plate according to (15), wherein it comprises a step of peeling off from the relief-forming layer the foam sheet that has covered the relief-forming layer for the second time.

### DETAILED DESCRIPTION OF THE INVENTION

### Modes for Carrying Out the Invention

The flexographic printing plate precursor for laser engraving of the present invention comprises a support, a relief-forming layer provided above the support, and a foam sheet covering the relief-forming layer, the foam sheet having a surface roughness Ra of 0.02 to 1.0 mm.

Hereinafter, the support, the relief-forming layer, and the foam sheet covering the surface thereof, which are essential constituents of the layer structure, are explained in sequence. Furthermore, this foam sheet may be called a ‘cover sheet’ as appropriate.

### <Relief-Forming Layer>

The relief-forming layer is a recording layer that can form a relief printing layer of a flexographic printing plate by laser engraving, and is preferably a crosslinked layer that is insoluble in water or a solvent. The relief-forming layer is preferably formed from a resin composition described later.

The relief-forming layer is preferably formed by coating a support with a relief-forming composition that is soluble in a solvent, and this relief-forming layer is further subjected to crosslinking to thus give a crosslinked relief-forming layer. When a flexographic printing plate is made by directly laser-engraving the crosslinked relief-forming layer, due to the crosslinked structure of the relief-forming layer, a flexographic printing plate having a relief layer with a sharp cross-sectional shape after laser engraving can be obtained, and wear of the relief layer during printing can be prevented.

The relief-forming layer is formed by molding the composition for the relief-forming layer into a sheet or sleeve shape. The relief-forming layer is usually provided above a support, which is described later, but may be directly formed on the surface of a member such as a cylinder of plate-making or printing equipment, or placed and immobilized thereon. In this case, the cylinder, etc. functions as a support.

It is mainly a case in which the relief-forming layer is formed above a sheet-shaped support or a continuous sheet (web)-shaped support that is explained below as an example. A web-shaped support is processed into a sheet shape by appropriately cutting it.

### <Support>

A material for use as the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used because of high dimensional stability. The shape of the support depends on whether the relief-forming layer is sheet-like or sleeve-like.

An adhesive layer may be provided as an optional adhesive layer between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Cover Sheet>

In order to prevent the surface of the relief-forming layer from having unevenness or damage such as a mark and in order to prevent it being dented, the surface of the relief-forming layer is covered with a foam sheet. The foam sheet is preferably provided so as to directly cover the surface of the relief-forming layer. Although a mode in which covering is carried out via a slip coat layer as appropriate is not excluded, it is preferable for a slip coat layer not to be present.

The thickness of the foam sheet used as the cover sheet is not particularly limited, but from the viewpoint of reliability of operations such as covering and peeling off, the lower limit is preferably 0.1 mm, more preferably 0.15 mm, yet more preferably 0.2 mm, and particularly preferably 0.5 mm. From the viewpoint of economic efficiency, the upper limit for the thickness of the cover sheet is preferably 5 mm, more preferably 4 mm, yet more preferably 3 mm, and particularly preferably 2 mm. The foam sheet has a numerical range that is a combination of these lower and upper limits.

Examples of the material for use as a slip coat layer preferably includes as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

The material of this foam cover sheet is preferably an organic polymer material; examples thereof include polyurethane, a polyolefin-based foam sheet such as PE (polyethylene) or PP (polypropylene), a polyurethane-based foam sheet such as polyurethane, and a rubber-based foam sheet such as synthetic rubber or natural rubber (natural rubber, chloroprene rubber, ethylene propylene rubber). The cover sheet used in the present invention is more preferably a soft urethane sponge sheet or polyethylene sponge sheet, and is produced by a foaming method.

The surface of the cover sheet of the present invention has a large surface roughness Ra; the numerical range of the roughness Ra is 0.02 to 1.0 mm, preferably 0.03 to 0.5 mm, and more preferably 0.03 to 0.1 mm. The Ra is an Ra value measured by a non-contact optical method, and as a representative example it is measured by a VK9710 laser microscope manufactured by Keyence Corporation.

The relatively large Ra is due to concave bubbles on the cover sheet surface rather than convex projections on the cover sheet surface. Furthermore, in the present invention, the contact area between the relief-forming layer and the foam sheet surface is smaller than the contact area with a sheet having no bubbles. In this respect, the foam sheet has the opposite tendency to that of a cover sheet having inorganic particles kneaded thereinto.

The surface of these foam sheets has preferably a smaller surface area that is in contact with the relief-forming layer than that of a flat sheet. Because of the smallness of this contact area, sticking of the cover sheet to the relief layer of the flexographic printing plate precursor is suppressed, and at a time after producing the printing plate precursor and at the time of covering for a second time with the cover sheet, hardly any unevenness or marks occur on the relief layer surface.

Patent Document 2 discloses a cover film having improved adhesive power by the use as a cover sheet of a matt film having silica particles kneaded thereinto.

Specific examples of the cover sheet having the above surface roughness include a urethane sheet sold by MonotaRO Co., Ltd. (Ohtsu Chemical Co., Ltd.), a fluoro rubber sheet (Togawa Rubber Co., Ltd.), urethane sponge sheet 308 (thickness: 0.5, 1, 2, 5 mm), polyethylene sponge sheet LD33 (thickness: 3 mm), and polyethylene sponge sheet L2500 (thickness: 1.5 mm) manufactured by Fuji Gomu Co. Ltd.

The foam sheet used in the present invention preferably has a density of 10 to 80 kg/m³, and more preferably 20 to 50 kg/m³. Furthermore, the cover sheet preferably has a compression pressure of 30 to 100 kPa, and more preferably 50 to 80 kPa.

The cover sheet can easily be peeled off from the relief-forming layer (recording layer) of the flexographic printing plate precursor. When the cover sheet is peeled off from the relief-forming layer at a peel-off angle of approximately 90°, it is preferable that about half of the entire length of the cover sheet is lifted up and the flexographic printing plate precursor subsequently falls off due to its own weight, and it is more preferable that the printing plate precursor is hardly lifted up at all.

With regard to the cover sheet used in the present invention, since bubbles are present on the foam sheet surface, the contact area between the relief-forming layer and the cover sheet is small compared with a flat cover sheet, and sticking of the cover sheet is suppressed. In addition, a sheet having a matting agent adhered to the surface of a resin sheet and a sheet subjected to a sandblasting treatment are not suitable in the present invention since, as shown in Patent Document 2, although the surface roughness Ra of the cover sheet is on the order of a few μm, the surface area of the cover sheet is larger than that of a flat cover sheet, and sticking to the relief-forming layer tends to intensify.

Furthermore, in the present invention, with regard to a printing plate precursor from which a cover sheet has been removed, the surface of its relief-forming layer may be covered for a second time with a cover sheet as necessary. In this case, the cover sheet that has been peeled off once may be re-used for covering the relief-forming layer. A foam sheet having a large surface roughness Ra may suitably be used for repeated covering.

In the present invention, even if the relief-forming layer is covered for a second time with a cover sheet, the relief-forming layer is resistant to the occurrence of transfer marks such as unevenness or marks.

### <Preferred Components of Relief-Forming Layer>

In the present invention, the relief-forming layer preferably comprises a binder polymer and a photothermal conversion agent. (Component A) a binder polymer and (Component C) a photothermal conversion agent are explained in detail.

### (Component A) Binder Polymer

A relief-forming layer of a flexographic printing plate precursor for laser engraving of the present invention comprises preferably (Component A) a binder polymer.

The binder polymer is a macromolecular component contained in the relief-forming layer for laser engraving. Common high molecular compounds can appropriately be selected, one type thereof may be used on its own, or two or more types may be used in combination. In particular, the binder polymer for use as a printing plate precursor is preferably cross-linkable and can be selected in consideration of various performances such as laser engraving property, ink acceptance property, and engraving residue dispersibility.

The binder polymer may be selected and used from a polystyrene resin, polyester resin, polyamide resin, polysulfone resin, polyether sulfone resin, polyimide resin, hydroxyethylene unit-containing hydrophilic polymer, acrylic resin, acetal resin, epoxy resin, polycarbonate resin, rubber, thermoplastic elastomer, or the like.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038. Moreover, for example, when the purpose is to form a relief-forming layer having softness and flexibility, a soft resin or a thermoplastic elastomer is selected. Such material is described in detail in JP-A-2008-163081, paragraphs 0039 to 0040. Furthermore, in a case where the resin composition for laser engraving is applied to the relief-forming layer in the flexographic printing plate precursor for laser engraving, from the viewpoint of easy preparation of the composition for the relief-forming layer, and the improvement of resistance properties for an oil-based ink in the obtained flexographic printing plate, the use of a hydrophilic or alcoholphilic polymer is preferable. As the hydrophilic polymer, those described in detail in JP-A-2008-163081, paragraph 0041 can be used.

In addition, when being used for the purpose of curing by heating and exposure and improving strength, a polymer having an ethylenically unsaturated bond in the molecule is preferably used.

As such a polymer, examples of the polymer having an ethylenically unsaturated bond at the main chain include SB(polystyrene-polybutadiene), SBS(polystyrene-polybutadiene-polystyrene), SIS(polystyrene-polyisoprene-polystyrene), and SEBS(polystyrene-polyethylene/polybutylene-polystyrene).

The polymer having an ethylenically unsaturated bond at the side chain can be obtained by introducing an ethylenically unsaturated group such as an allyl group, an acryloyl group, a methacryloyl group, a styryl group, and a vinyl ether group into a structure of binder polymer below. As a method of introducing an ethylenically unsaturated group into the side chain of the binder polymer, known methods may be employed, such as (1) a method in which structural units having a polymerizable group precursor obtained by protecting a polymerizable group are copolymerized with the polymer and the protecting group is eliminated to obtain a polymerizable group and (2) a method in which a high molecular compound having a plurality of reactive group such as a hydroxy group, an amino group, an epoxy group, and a carboxyl group is prepared and a compound having a group which can react with the reactive group and an ethylenically unsaturated group is introduced by polymer reaction. According to these methods, the amount of an ethylenically unsaturated group introduced into the high molecular compound can be controlled.

The binder polymer (Component A) is preferably a binder polymer having a functional group (hereinafter, called a ‘reactive functional group’ as appropriate) that can react with a hydrolysable silyl group and/or silanol group of (Component B) a compound having a hydrolysable silyl group and/or silanol group to thus form a crosslinked structure.

The reactive functional group that is contained in Component A is not particularly limited as long as it is a group that can react with a hydrolysable silyl group and/or silanol group of Component B to thus form a siloxane (—Si—O—) bond, and a hydroxy group, a silanol group, and a hydrolysable silyl group are preferable.

The above reactive functional group may be present at any locations in polymer molecules, but is preferably present at the side chain of the branched polymer. Preferred examples of such a polymer include a vinyl copolymer (copolymer of a vinyl monomer such as polyvinyl alcohol and polyvinyl acetal, and a derivative thereof) and an acrylic resin (copolymer of an acryl-based monomer such as hydroxyethyl(meth)acrylate, and a derivative thereof).

A method of introducing the reactive functional group into the binder polymer is not particularly limited, and a method of addition-(co)polymerizing or addition-polycondensating a monomer having the reactive functional group and a method in which, after synthesizing a polymer having a group which can be introduced into the reactive functional group, the polymer is introduced into the reactive functional group by polymer reaction are included thereto.

The relief-forming layer preferably comprise carbon black as the photothermal conversion agent (Component C).

The photothermal conversion agent referred to here is a substance that can absorb light having a wavelength of 700 to 1,300 nm. That is, it is surmised that the photothermal conversion agent in the present invention absorbs light of a laser to which it is exposed and generates heat, thus promoting thermal decomposition of the relief-forming layer. Because of this, it is preferable to select a photothermal conversion agent that absorb light of the wavelength of the laser used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, and Spezialschwarz (registered trademark) 4 (Degussa).

From the viewpoint of improving engraving sensitivity by efficiently transmitting heat generated by photothermal conversion to the surrounding polymer, etc., the carbon black that can be used in the present invention is preferably a conductive carbon black having a specific surface area of at last 150 m²/g and a DBP number of at least 150 mL/100 g.

This specific surface area is preferably at least 250 m²/g, and particularly preferably at least 500 m²/g. The DBP number is preferably at least 200 mL/100 g, and particularly preferably at least 250 mL/100 g. The above-mentioned carbon black may be acidic or basic carbon black. The carbon black is preferably basic carbon black. It is of course possible to use a mixture of different carbon blacks.

Conductive carbon black having a specific surface area of 150 to about 1,500 m²/g and a DBP number of 150 to about 550 mL/100 g is commercially available under names such as for example Ketjenblack (registered trademark) EC300J, Ketjenblack (registered trademark) EC600J (Akzo), Printex (registered trademark) XE (Degussa), Black Pearls (registered trademark) 2000 (Cabot), and Ketjen Black (Lion Corporation).

When carbon black is used as the photothermal conversion agent, thermal crosslinking is more preferable in point of the curability of the relief-forming layer, instead of the photo crosslinking using UV light etc., and, by the combination with the organic peroxide as the polymerization initiator, which is the aforementioned preferable component for use in combination, the engraving sensitivity becomes extremely high, to give more preferable results.

Examples of most preferred modes of the present invention include a mode in which (Component A) a binder polymer is used in combination with carbon black, which is a photothermal conversion agent that can absorb light having a wavelength of 700 to 1,300 nm (Component C).

The content of (Component C) the photothermal conversion agent capable of absorbing light having a wavelength of 700 to 1,300 nm in the relief-forming layer for laser engraving greatly varies depending on the molecular extinction coefficient inherent to the molecule, and, relative to the total solid content of the relief-forming layer, 0.01 to 20 wt % is preferable, 0.05 to 10 wt % is more preferable, and 0.1 to 5 wt % is particularly preferable.

In the present invention, the relief-forming layer preferably has a siloxane bond. This siloxane bond may be formed by the use in combination of Component B below.

(Component B) Compound Having Hydrolysable Silyl Group and/or Silanol Group

In the present invention, the relief-forming layer is preferably formed from a composition comprising (Component B) a compound having a hydrolysable silyl group and/or silanol group.

The relief-forming layer preferably comprises a siloxane bond due to Component B being used in combination with Component A.

The ‘hydrolyzable silyl group’ of Component B used in the resin composition for laser engraving for use to form a relief-forming layer is a silyl group that is hydrolyzable; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (I) below.

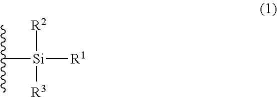

In Formula (I) above, R¹ to R³ denote independently a hydrolyzable group selected from the group consisting of an alkoxy group, an aryloxy group, a mercapto group, a halogen atom, an amide group, an acetoxy group, an amino group, and an isopropenoxy group, or a hydroxy group, a hydrogen atom, or a monovalent organic group. At least one of R¹ to R³ denotes a hydrolyzable group selected from the group consisting of an alkoxy group, an aryloxy group, a mercapto group, a halogen atom, an amide group, an acetoxy group, an amino group, and an isopropenoxy group, or a hydroxy group. A wavy portion denotes a bonding position to another structure.

When R¹ to R³ denote a monovalent organic group, from the viewpoint that solubility in various types of organic solvents can be given, an organic group is preferably an alkyl group having 1 to 30 carbon atoms.

In Formula (I) above, the hydrolyzable group bonded to the silicon atom is particularly preferably an alkoxy group or a halogen atom.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms.

Furthermore, examples of the halogen atom include a F atom, a Cl atom, a Br atom, and a I atom, and from the viewpoint of ease of synthesis and stability it is preferably a Cl atom or a Br atom, and more preferably a Cl atom.

Component B is preferably a compound having one or more groups represented by Formula (I) above, and more preferably a compound having two or more. As Component B compound having two or more hydrolyzable silyl groups is particularly preferably used.

Moreover Component B is preferably a compound having in the molecule two or more silicon atoms. The number of silicon atoms in the compound is preferably at least 2 but no greater than 6, and most preferably 2 or 3.

A range of 1 to 3 of the hydrolyzable groups may bond to one silicon atom, and the total number of hydrolyzable groups in Formula (I) is preferably in a range of 2 or 3. It is particularly preferable that three hydrolyzable groups are bonded to a silicon atom. When two or more hydrolyzable groups are bonded to a silicon atom, they may be identical to or different from each other.

Examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group. A plurality of each of these alkoxy groups may be used in combination, or a plurality of different alkoxy groups may be used in combination.

Examples of the aryloxy group include phenoxy group. Examples of the aryloxysilyl group having an aryloxy group bonded thereto include a triarylsilyl group such as a triphenylsilyl group.

In the present invention, the relief-forming layer may be formed from a resin composition comprising Components 1 to 3 below.

(Component 1) a resin that is a plastomer at 20° C. and comprises a group selected from the group consisting of groups represented by Formula (I) to Formula (III),
(Component 2) an ethylenically unsaturated compound, and
(Component 3) a polymerization initiator.

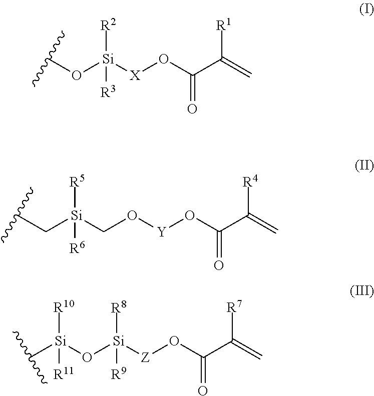

(In Formula (I) to Formula (III) X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.)

### <Solvent>

In the present invention, a solvent that is used when preparing the resin composition for laser engraving is preferably an organic solvent from the viewpoint of the solubility of each component. Specifically, a protic organic solvent may preferably be used.

Specific preferred examples of the protic organic solvent include methanol, ethanol, 1-propanol, 2-propanol, 1-butanol, 1-methoxy-2-propanol, ethylene glycol, diethylene glycol, 1,3-propanediol and 2-propylene glycol 1-methyl ether acetate. Among these 2-propylene glycol 1-methyl ether acetate (propylene glycol methyl ether acetate) is preferable.

In the present invention, the resin composition of a relief-forming layer for laser engraving preferably comprises a plasticizer. The plasticizer has the function of softening a relief-forming layer formed from the resin composition for laser engraving, and it is necessary for it to be compatible with the binder polymer.

Preferred examples of the plasticizer include tributyl citrate, dioctyl phthalate, didodecyl phthalate, a polyethylene glycol (monool form or diol form) and a polypropylene glycol (monool form or diol form).

### <Alcohol Exchange Reaction Catalyst>

The resin composition for laser engraving may comprise an alcohol exchange reaction catalyst, and it may use only one type or two or more types in combination.

Examples of the catalyst include an acidic catalyst, a basic catalyst, and a metal complex catalyst, and an acidic catalyst or a basic catalyst is preferable.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acid, inorganic solid acid etc, and examples of the basic catalyst include an ammoniacal base such as aqueous ammonia, an amine such as ethyl amine and aniline etc. alkaline metal hydroxides, alkaline metal alkoxides, alkaline-earth oxides, tertiary ammonium salt compounds, and tertiary phosphonium salt compounds.

The content of the alcohol exchange reaction catalyst is not specifically limited in the resin composition and can be determined appropriately depending on the characteristics of the specific alcohol exchange reaction catalyst used.

### <Other Additives>

In the present invention, the resin composition for laser engraving may comprise an additive other than Component A to Component C above or Components 1 to 3 as appropriate in an amount that does not inhibit the effects of the present invention. Examples include a fragrance, a filler, a wax, a process oil, a metal oxide, an antiozonant, an antioxidant, a thermal polymerization inhibitor, and a colorant, and for each thereof one type may be used on its own or two or more types may be used in combination.

### <Layered Product>

Another aspect of the present invention relates to a layered product of the flexographic printing plate precursor for laser engraving, and is a layered product formed by layering the flexographic printing plate precursor for laser engraving according to any one of (1) to (5) above. The number of layers may be selected as appropriate, but it is preferable to layer 5 to 1,000 sheets, more preferably 10 to 100 sheets, and particularly preferably 10 to 30 sheets. In this layered product, it is unnecessary to provide between the flexographic printing plate precursors a paper slip sheet other than the foam sheet. This is because the cover sheet formed from the foam sheet has resilience and prevents the flexographic printing plate precursors from damaging each other.

### <Process for Producing Flexographic Printing Plate Precursor for Laser Engraving>

The process for producing a flexographic printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, the outer surface of the relief-forming layer is covered with the cover sheet. In the covering step, the foam sheet is put into intimate contact with the relief-forming layer by pressing the foam sheet and the relief-forming layer by means of heated calender rolls, etc.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving is prepared, solvent is partially removed as necessary from this resin composition for laser engraving, and the resulting resin composition for laser engraving is cast onto a support, and this is dried in an oven to thus remove solvent.

The resin composition for laser engraving may be produced for example by dissolving or dispersing Component A to Component C and an optional component in an appropriate solvent and then mixing the liquids. Since most of the solvent component is preferably removed during a stage of producing the flexographic printing plate precursor, as the solvent a low-molecular-weight alcohol that is easily evaporated (e.g. methanol, ethanol, n-propanol, isopropanol, propylene glycol monomethyl ether), etc. may be used, and the total amount of solvent added is preferably minimized by carrying out preparation at a temperature that is higher than room temperature.

The thickness of the (crosslinked) relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

Heating the flexographic printing plate precursor for laser engraving enables the relief-forming layer to be crosslinked (thermal crosslinking step). As heating means for carrying out thermal crosslinking, a method in which a printing plate precursor is heated in a hot air oven or a far infrared oven for a predetermined time or a method in which it is contacted with a heated roll for a predetermined time can be cited.

Thermally crosslinking the relief-forming layer gives the first advantage that a relief formed after laser engraving becomes sharp and the second advantage that tackiness of engraving residue formed during laser engraving is suppressed.

Furthermore, when a photopolymerization initiator, etc. is used, in order to polymerize the polymerizable compound and form crosslinking, photo crosslinking may be further carried out as necessary.

When the relief-forming layer comprises a photopolymerization initiator, by irradiating the relief-forming layer with actinic radiation that can trigger the photopolymerization initiator, the relief-forming layer may be crosslinked.

Exposure to light may be usually carried out for the entire surface of the relief-forming layer. Examples of the light (also called ‘actinic radiation’) include visible light, UV light, and an electron beam, and UV light is most common. If the substrate side for immobilizing the relief-forming layer such as the support side of the relief-forming layer is defined as the reverse face, only the front face may be irradiated with light, but when the support is a cover sheet that can transmit actinic radiation, it is preferable to further irradiate from the reverse face with light as well. Irradiation from the front face may be carried out after affixing the cover sheet and while it is being provided, or it may be carried out before covering with the cover sheet. In the case of curing by radical polymerization, since there is a possibility of inhibition of polymerization if oxygen is present, irradiation with actinic radiation may be carried out while maintaining the relief-forming layer under reduced pressure.

<Step of Covering for Second Time with Foam Sheet>

Yet another aspect of the present invention relates to a process for making a flexographic printing plate, and comprises a step of preparing the flexographic printing plate precursor according to any one of (1) to (5) above, a peeling off step of peeling off a cover sheet from the flexographic printing plate precursor, and an engraving step of directly laser-engraving a relief-forming layer to thus form a relief layer.

In the process for making a flexographic printing plate, subsequent to the peeling off step but prior to the laser engraving, a step of covering the relief-forming layer for a second time with a foam sheet may be included. As this foam sheet, a foam sheet that has been peeled off once from the relief-forming layer may be used.

When a foam sheet is used for covering a second time, the engraving step is carried out after this foam sheet is peeled off. In the engraving step, it is preferable to engrave the relief-forming layer by means of a fiber-coupled semiconductor laser having a wavelength of 700 to 1,300 nm.

### <Process for Making Flexographic Printing Plate>

The process for making a flexographic printing plate of the present invention preferably comprises a step of preparing the flexographic printing plate precursor for laser engraving of the present invention, a peeling off step of peeling off the foam sheet from the flexographic printing plate precursor, and an engraving step of directly laser-engraving the relief-forming layer to thus form a relief layer.

The flexographic printing plate of the present invention is obtained, as essential steps, by a step of forming a relief-forming layer from a resin composition for laser engraving, a crosslinking step of crosslinking this relief-forming layer, and a step of covering this crosslinked relief-forming layer with a foam sheet.

The process for making a flexographic printing plate of the present invention comprises, subsequent to a step of peeling off and removing the foam sheet from the flexographic printing plate precursor for laser engraving, an engraving step of laser-engraving the exposed relief-forming layer.

The flexographic printing plate thus obtained may be suitably used in printing with an aqueous ink and an oil-based ink.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, and in ‘Practical Laser Technology’ The Institute of Electronics and Communication Engineers, etc.

Moreover, as plate making equipment comprising a fiber-coupled semiconductor laser that can be usable suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The flexographic printing plate having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present invention is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention can be used in printing using any ink, such as an aqueous ink, an oil-based ink, or a UV ink in a letterpress printer, and printing is also possible in a flexographic printer using a UV ink. The flexographic printing plate of the present invention has excellent rinsing properties and little engraving residue, and can give a relief layer that has excellent printing durability; printing is possible for a long period of time without concerns about plastic deformation or degradation of the printing durability of the relief layer.

In accordance with the present invention, there can be provided a flexographic printing plate precursor for laser engraving comprising a cover sheet that does not cause unevenness or marks in a plate material. In accordance with the present invention, there also can be provided a process for making a flexographic printing plate that can prevent the occurrence of unevenness or marks in a plate material even if a step of covering a relief-forming layer for a second time with a sheet that has been peeled off once is carried out.

### EXAMPLES

The present invention is explained below in further detail by reference to Examples, but the present invention is not limited to these Examples.

### <Preparation of Flexographic Printing Plate Precursor>

### 1. Preparation of Resin Composition for Laser Engraving

A three-necked flask equipped with a stirring blade and a condenser was charged with 50 parts by weight of Gohsenal T-215 (The Nippon Synthetic Chemical Industry Co., Ltd., water-soluble PVA) as a specific polymer and 47 parts by weight of propylene glycol monomethyl ether acetate as a solvent, and the polymer was dissolved by heating at 70° C. while stirring for 120 minutes. Subsequently, the solution was set at 40° C., 15 parts by weight of tributyl citrate as a plasticizer, 8 parts by weight of Blemmer LMA (NOF Corporation) as a polymerizable compound (monofunctional form), 1.6 parts by weight of Perbutyl Z (NOF Corporation) as a polymerization initiator, and 1 part by weight of carbon black (Sho Black N110, Cabot Corporation Japan, DBP oil adsorption 115 mL/100 g) as a photothermal conversion agent were added thereto, and stirring was carried out for 30 minutes. Following this, 15 parts by weight of (A) Compound (I) (S-15) (structure shown below; available from Shin-Etsu Chemical Co., Ltd. as product name KBE-846) and 0.4 parts by weight of phosphoric acid as a catalyst were added, and stirring was carried out at 40° C. for 10 minutes. These operations gave a flowable coating solution for a relief-forming layer (resin composition for laser engraving).

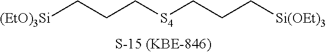

wherein Et denotes an ethyl group.

### 2. Preparation of Flexographic Printing Plate Precursor for Laser Engraving

A spacer (frame) having a predetermined thickness was placed on a PET support, and the coating solution for a relief-forming layer obtained above was cast gently so that it did not overflow from the spacer (frame) and dried in an oven at 90° C. for 3 hours, thus providing a relief-forming layer having a thickness of about 1 mm.

### Example 1

The surface of the relief-forming layer thus produced was covered with a urethane foam (308, Fuji Gomu Co., Ltd., thickness 0.5 mm) as a foam sheet, thus giving a cover sheet-equipped printing plate precursor. 10 sheets of this printing plate precursor were superimposed, a weight corresponding to 15 kgw/m² was first applied thereto, and they were stored at 60° C. for 23 days and further at room temperature for 24 days, thus giving a printing plate precursor of Example 1.

### Examples 2 to 8 and Comparative Examples 1 to 3

Examples 2 to 8 and Comparative Examples 1 to 3 were obtained in the same manner as in Example 1 except that a cover sheet shown in Table 1 was used instead.

The cover sheets used in Examples 1 to 8 and Comparative Examples 2 and 3 were manufactured by Fuji Gomu Co., Ltd.

The density of the foam sheet used was as follows.

Urethane foam (308; Examples 1 to 4): 20 kg/m³
Polyethylene sponge sheet (LD33; Example 5): 33 kg/m³
Polyethylene sponge sheet (L2500; Example 6): 25 kg/m³
Rubber sponge sheet (FGCR; Example 7): 75 kg/m³
Copier paper (Fuji Xerox Co., Ltd.; Comparative Example 1): 800 kg/m³
Urethane foam (UMF30; Comparative Example 2): 30 kg/m³
Polyethylene sponge sheet (L4400; Comparative Example 3): 44 kg/m³
Urethane foam (U0016; Example 8): 16 kg/m³

### <Measurement of Surface Roughness (Ra) of Cover Sheet>

Measurement of the surface roughness of the cover sheet was carried out by a non-contact method using laser light by means of a VK710 laser microscope manufactured by Keyence Corporation.

### Evaluation

Examples 1 to 8 and Comparative Examples 1 to 3 obtained above were subjected to visual examination in terms of the condition of sticking and transfer marks. Furthermore, the repeat usability as a cover sheet was evaluated. The surface roughness Ra (mm) was measured.

### <Evaluation of Sticking>

Evaluation of sticking was carried out by visually examining the condition when the cover sheet was lifted up at an angle of 90°, and evaluation was made in accordance with the evaluation criteria below.

A: the printing plate precursor was not lifted up.
B: about half of the printing plate precursor was lifted up, and then peeled off and fell.
C: lifted up while sticking.

### <Evaluation of Transfer Marks>

Evaluation of transfer marks was carried out by visually examining the surface of the relief-forming layer after the cover sheet was peeled off from the relief-forming layer. The evaluation criteria were as follows.

A: there was no transfer of cover sheet marks to the surface.
B: slight marks were observed, but very faint.
C: marks were completely transferred.

### <Repeat Usability>

Evaluation was made as to whether or not the relief-forming layer could be covered for a second time with a cover sheet that had been peeled off from the relief-forming layer.

A: could be used repeatedly.
B: could not be used repeatedly.

It can be seen from Table 1 that when a cover sheet having an Ra value of 0.02 mm to 1.0 mm was used, sticking to the relief-forming layer could be prevented, there were no transfer marks and, furthermore, it could be used repeatedly, which is preferable in terms of the environment and cost.

TABLE 1

| | | | Surface | | | |
|---|---|---|---|---|---|---|
| | | Thickness | roughness | | Transfer | Repeat |
| | Cover sheet | (mm) | Ra (mm) | Sticking | marks | usability |
| Example 1 | Urethane foam 308 | 0.5 | 0.056 | A | A | A |
| Example 2 | Urethane foam 308 | 1.0 | 0.056 | A | A | A |
| Example 3 | Urethane foam 308 | 2.0 | 0.056 | A | A | A |
| Example 4 | Urethane foam 308 | 5.0 | 0.056 | A | A | A |
| Example 5 | Polyethylene sponge sheet: LD33 | 3.0 | 0.037 | A | B | A |
| Example 6 | Polyethylene sponge sheet: L2500 | 1.5 | 0.034 | B | B | A |
| Example 7 | Rubber sponge sheet: FGCR0 | 1.5 | 0.041 | B | B | A |
| Example 8 | Urethane foam: U0016 | 5.0 | 0.70 | A | A | A |
| Comp. Ex. 1 | Copier paper (Fuji Xerox Co., Ltd.) | 0.05 | 0.0062 | C | C | C |
| Comp. Ex. 2 | Urethane foam: UMF30 | 1.0 | 1.12 | B | C | A |
| Comp. Ex. 3 | Polyethylene sponge sheet: L4400 | 1.0 | 0.015 | C | C | A |

What is claimed is:

1. A flexographic printing plate precursor for laser engraving comprising:
a support;
a relief-forming layer provided above the support; and
a foam sheet covering the relief-forming layer,
the foam sheet having a surface roughness Ra of 0.02 to 1.0 mm.

2. The flexographic printing plate precursor for laser engraving according to claim 1, wherein the foam sheet surface area that is in contact with the relief-forming layer is smaller than that of a flat sheet.

3. The flexographic printing plate precursor for laser engraving according to claim 1, wherein the surface roughness Ra is 0.03 to 0.5 mm.

4. The flexographic printing plate precursor for laser engraving according to claim 1, wherein the surface roughness Ra is 0.03 to 0.1 mm.

5. The flexographic printing plate precursor for laser engraving according to claim 1, wherein the foam sheet has a density of 10 to 80 kg/m³.

6. The flexographic printing plate precursor for laser engraving according to claim 1, wherein the foam sheet has a thickness of at least 0.1 mm but no greater than 5 mm.

7. The flexographic printing plate precursor for laser engraving according to claim 1, wherein the foam sheet is a foam sheet of polyurethane or polyethylene.

8. The flexographic printing plate precursor for laser engraving according to claim 1, wherein the relief-forming layer comprises a binder polymer and a photothermal conversion agent.

9. The flexographic printing plate precursor for laser engraving according to claim 8, wherein it comprises carbon black as the photothermal conversion agent.

10. The flexographic printing plate precursor for laser engraving according to claim 1, wherein the relief-forming layer comprises a siloxane bond.

11. A layered product in which the flexographic printing plate precursor for laser engraving according to claim 1 is layered.

12. The layered product according to claim 11, wherein 5 to 1,000 sheets of the flexographic printing plate precursor for laser engraving are layered.

13. A process for producing the flexographic printing plate precursor for laser engraving according to claim 1, comprising:
a step of forming a relief-forming layer by coating a support with a resin composition comprising a binder polymer and a photothermal conversion agent;
a crosslinking step of crosslinking the relief-forming layer by means of light and/or heat to thus form a crosslinked relief-forming layer; and
a step of covering the crosslinked relief-forming layer with the foam sheet.

14. A process for making a flexographic printing plate, comprising:
a step of preparing the flexographic printing plate precursor for laser engraving according to claim 1;
a peeling off step of peeling off the foam sheet from the flexographic printing plate precursor for laser engraving; and
an engraving step of directly laser-engraving the relief-forming layer to thus form a relief layer.

15. The process for making a flexographic printing plate according to claim 14, wherein it comprises, subsequent to the peeling off step, a step of covering the relief-forming layer for a second time with a foam sheet.

16. The process for making a flexographic printing plate according to claim 14, wherein in the engraving step engraving is carried out by means of a fiber-coupled semiconductor laser having a wavelength of 700 to 1,300 nm.

17. The process for making a flexographic printing plate according to claim 15, wherein it comprises a step of peeling off from the relief-forming layer the foam sheet that has covered the relief-forming layer for the second time.
